(19) United States
(12) Patent Application Publication
(10) Pub. No.: US 2002/0004866 A1
(43) Pub. Date: Jan. 10, 2002

(54) Hardware method to reduce CPU code latency

(76) Inventor: Thomas W. Bucht, Hillsboro, OR (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/851,594

(22) Filed: May 8, 2001

Related U.S. Application Data
(60) Provisional application No. 60/202,718, filed on May 8, 2000.

(51) Int. Cl. G06F 13/00

(52) U.S. Cl. 710/107

(57) ABSTRACT

An apparatus for reducing CPU latency by reducing CPU bus read/write cycles, the apparatus includes a hardware register capable of testing data for one or more validity bits. A CPU is in communication with the hardware register during a first bus cycle and the CPU directs the hardware register to drive the data substantially simultaneously to the CPU and a second register. The data validity signal is performed in close proximity to the data transfer to the CPU and the second hardware device and the validity signal is forwarded to the second register without a subsequent bus cycle instruction to the second register from the CPU.

This application claims priority under 35 U.S.C. § 119(e) to provisional application No. 60/202,718, filed May 8, 2000, entitled “HARDWARE METHOD TO REDUCE CPU CODE LATENCY”, which is hereby fully incorporated by reference.

### BACKGROUND OF THE INVENTION

1. Field of the Invention

The present invention relates to read and write operations performed by a CPU in the operation of a hardware device, and more particularly to hardware devices that are used to trigger or perform a function in response to an event without the CPU directing the sequence of events.

2. Description of the Related Art

The prior art has employed software solutions to look up data from a hardware device, such as a memory storage device, or to trigger a hardware device such as a content addressable memory (CAM). CAMs are used to look up data based on another data pattern. For example, a fibre channel frame contains a destination address (data0), which is used to determine where the frame should be routed to (data1 in this example). Generally, the CPU reads data0 from a hardware register and writes data0 to a CAM. The CPU then reads the resulting data from the CAM and then makes a decision regarding the routing of the data. Software solutions, as employed in the prior art, have required a read-write-read (3-step) process to perform the reading of the data from the hardware register and the subsequent writing to the CAM by the CPU. This operation is inefficient and costly, especially when dealing with real time applications, as CPU time and resources are utilized for each of the read-write-read operations. Furthermore, each step requires a discrete amount of time to perform which slows the responsiveness of the system. The present invention provides a means to write to a hardware or similar device with the same data read by the CPU simultaneously, thus reducing the CPU bus cycle by at least one-third and reducing CPU latency in responding to real-time events.

### SUMMARY OF THE INVENTION

The present invention has been made in view of the above circumstances and has as an aspect an apparatus for reducing CPU code latency by eliminating bus cycles implemented by the CPU.

A further aspect of the present invention comprises a method of eliminating read/write operations by writing data to hardware devices on behalf of the CPU and forwarding data simultaneously to multiple devices.

Additional aspects and advantages of the invention will be set forth in part in the description which follows, and in part will be obvious from the description, or may be learned by practice of the invention. The aspects and advantages of the invention will be realized and attained by means o the elements and combinations particularly pointed out in the appended claims.

To achieve these and other advantages and in accordance with the purpose of the present invention, as embodied and broadly described, the present invention can be characterized according to one aspect the invention as comprising a method for reducing CPU code latency by writing data to hardware devices on behalf of said CPU, the method including directing a register to drive data via a first device; driving the data via the register to the first device and a second device simultaneously; sampling of the data by the register and determining whether the data is valid; and signaling the second device as to whether the data is valid or invalid.

A further aspect of the present invention can be characterized as an apparatus for reducing CPU bus cycle time and CPU latency in responding to real-time events, the apparatus including a CPU in communication with and capable of directing a first hardware device; the first hardware device responsive to the CPU and capable of driving data pursuant to instructions from the CPU, wherein the hardware device is further capable of; substantially simultaneously driving data to the CPU and a second hardware device; analyzing one or more bits from the data driven by the first hardware device in determining validity of the data; and transmitting a signal to the second hardware device regarding the validity of the data.

A still further aspect of the present invention can be characterized as an apparatus for reducing CPU latency by reducing CPU bus read/write cycles, the apparatus including a hardware register capable of testing data for one or more validity bits; a CPU in communication with the hardware register during a first bus cycle, wherein the CPU directs the hardware register to drive the data substantially simultaneously to the CPU and a second register and in close proximity to the data transfer, the hardware register sends a validity signal to the second register without a subsequent bus cycle instruction to the second register from the CPU.

It is to be understood that both the foregoing general description and the following detailed description are exemplary and explanatory only are not restrictive of the invention, as claimed.

### BRIEF DESCRIPTION OF THE DRAWINGS

The accompanying drawings, which are incorporated in and constitute a part of this disclosure, illustrate one embodiment of the invention and together with the description, serve to explain the principles on of the invention.

FIG. 1 is a schematic diagram of a conventional CPU, hardware register configuration employing a software solution;

FIG. 2 is a schematic diagram of one embodiment of the CPU, hardware configuration of the present invention;

FIG. 3 is a schematic diagram of an alternate embodiment of the CPU, hardware configuration of the present invention; and

FIG. 4 and FIG. 5 are schematic diagrams of inputs and logic employed by a hardware register of the present invention.

### DETAILED DESCRIPTION OF THE INVENTION

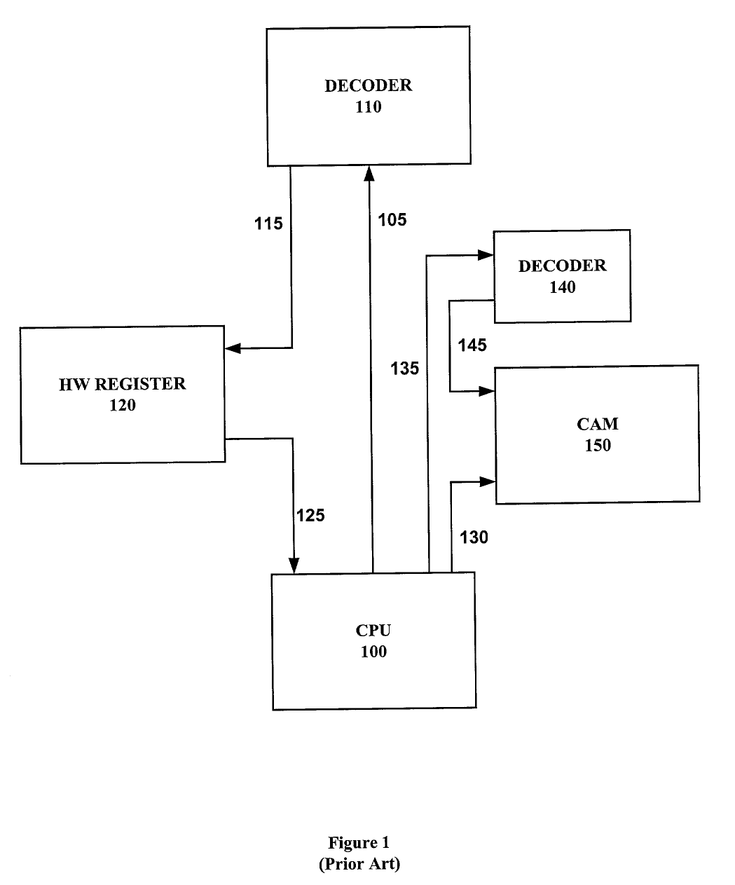

The present invention has been made in view of the above circumstances. FIG. 1 depicts a conventional hardware register 120, CPU 100, CAM 150, decoder 110 and Decoder 140 configuration.

The Decoder 110 is a conventional address decoder. It's inputs are CPU address and control lines. When the address output by CPU 100 on Bus 105 matches the pre-defined address of H/W register 120 and CPU control lines 105 indicate a valid bus cycle in progress, Decoder 110 activates its output signal 115, which directs H/W register 120 to place it's data on bus 125.

Hardware register 120 provides a real-time indication of changing events. For example, when H/W register 120 is connected to I/O port circuitry, H/W register 120 can provide an indication that a ‘frame’ of data has been received. This indication is provided by one or more bits changing state in the data which is read from H/W register 120 by CPU 100. H/W register 120 may also provide supplemental information, such as the destination address of the frame just received. H/W register 120 typically has ‘destructive’ reading characteristics, which means that one or more of the data bits read by CPU 100, will change state after the CPU read completes.

CPU 100 is a conventional Central Processing Unit, for example the Intel i960. In prior art FIG. 1, the CPU is responsible for: 1) reading H/W register 120; 2) making a decision whether to write the data to CAM 150, based on the data read from H/W register 120; 3) writing data to CAM 150; and 4) subsequently reading CAM 150 to retrieve data looked-up by CAM 150. The CAM or other writeable register is not written until: 1) the CPU completes the read of H/W register 120; 2) the CPU executes bit test and branch instructions; and 3) the CPU executes the instruction writing data to the CAM 150.

The CAM or Content Addressable Memory is a device which provides rapid look-up of information. In prior art FIG. 1, CPU 100 writes a destination address to CAM 150. When the data in CAM 150 is subsequently read back by the CPU, a port number is returned, providing routing information. Although a CAM is used in this example, any writeable device could be used in the place of the CAM.

The Decoder 140 is a conventional address decoder. The Decoder's inputs are CPU address and control lines. When the address output by CPU 100 on Bus 135 matches the pre-defined address of CAM 150 and CPU control lines 135 indicate a valid bus cycle in progress, the decoder activates its output signal 145, which directs CAM 150 to accept data on Bus 130 (write) or place it's data on bus 130 (read). Bus 135 is typically the same bus as Bus 125. Decoder 140 functions substantially the same as Decoder 110.

Returning once again to FIG. 1, an address and control signals are sent to decoder 110 via bus 105, which acts as a slave to the CPU 100. The decoder 110 interprets the information, (i.e. address and other control signals) and sends a signal to the hardware register identified by the CPU 100 as the device it desires to retrieve information from, such as a hardware register providing indications of real-time events or similar type device.

Decoder 110 sends a signal along 115 to H/W register 120 telling register 120 at what time, (i.e., bus cycle) to send the data to CPU 100. The data is sent along 125 to CPU 100. After CPU 100 has tested bits in the data retrieved, and has determined that the data is valid (or some further action is required), the CPU 100 then sends a signal to decoder 140 along bus 135. The signal tells the Decoder 140, which is a slave to CPU 100, to configure CAM 150 to wake up or pay attention to the data that is about to be sent to it. The signal is sent to CAM 150 along bus 145. Finally the data is sent along 130 from CPU 100 to CAM 150 where it is stored.

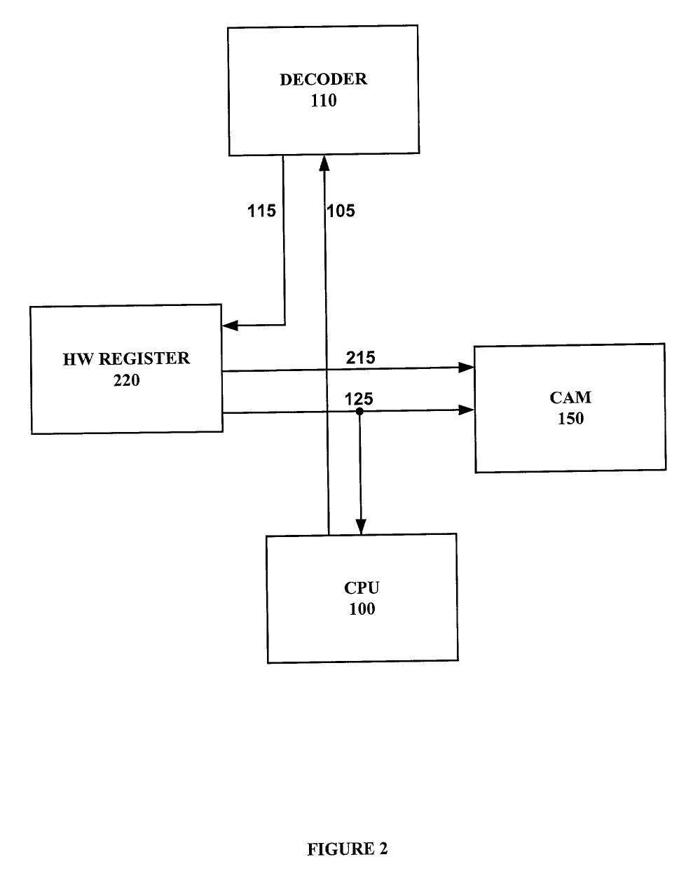

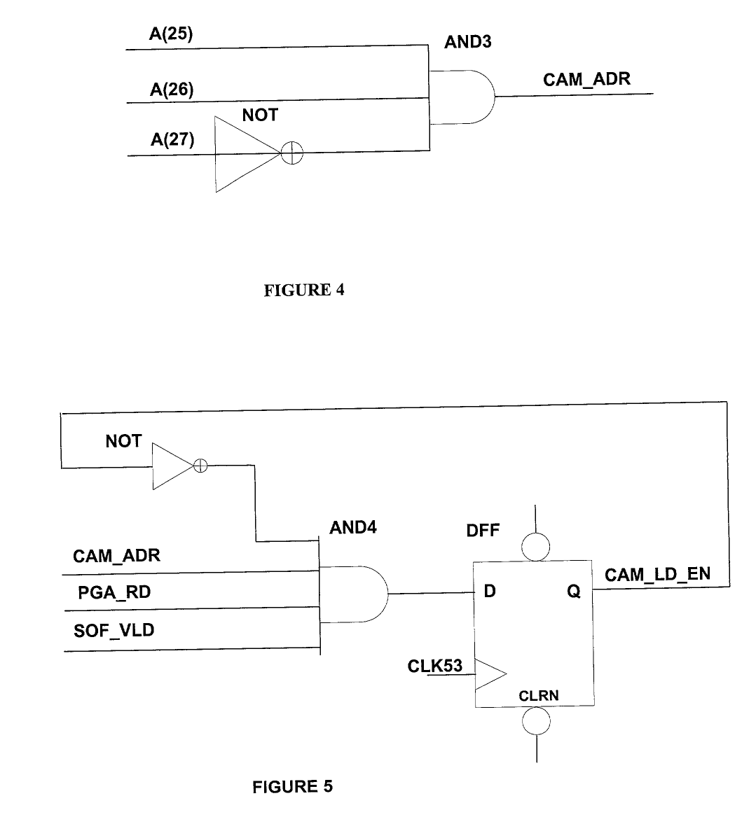

The present invention will now be described with reference to FIG. 2. CPU 100, as was the case in the prior art configuration of FIG. 1, sends a signal to decoder 110 along bus 105. The signal contains address information for the device from which to retrieve the desired data. In this embodiment the device is a hardware register 220, although it could have been any readable hardware device . The decoder 110 in turn sends a signal along 115 instructing register 220 to send the requested data. Register 220 also monitors the data it is sending on 125 and determines validity of the data, based on the logic imparted to register 220, by the logic diagrams of FIG. 4 and FIG. 5. The data is forwarded along 125 to CPU 100 and CAM 150 substantially simultaneously. Although a CAM is depicted as the receiving device, the device receiving the data could have been another hardware register, an output device such as a display or an alarm, or a host of other writable devices. Concurrently, or in close proximity to the data being sent along 125, a signal is also sent along 215 to CAM 150, or a similar type device capable of storing or acting upon the transmitted data.

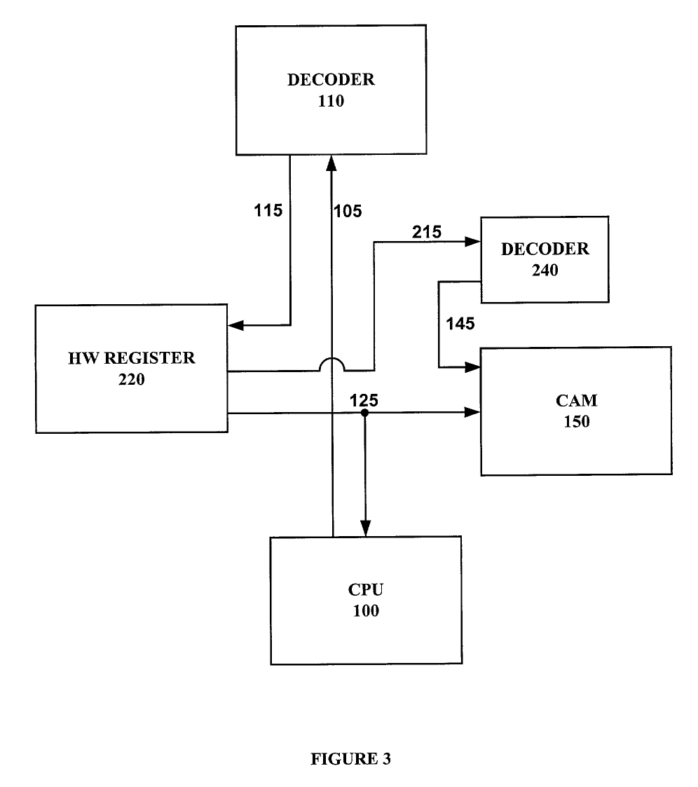

In an alternate embodiment, as shown in FIG. 3, a signal is sent to decoder 240 and instructs the decoder to prepare the CAM 150 or other device to receive and act on the data that is being sent to it. If a signal is not sent to decoder 240 from register 220 the data is ignored. The hardware register is capable of making the determination of whether the information is valid or not based on the data sent to the CPU 100. Determination of whether the data is valid can be determined by analyzing one or more bits of the data being transmitted. The bit or bits analyzed could be a bit indicating a frame valid or any other pre-defined bit pattern which signifies that a further action is required. In any event the register 220 is capable of making a determination as to the validity or importance of the data and acts accordingly.

By register 220 performing the determination function, this relieves CPU 100 from having to make the determination and also reduces CPU bus cycles and decreases system latency caused by CPU 100. As depicted in FIGS. 2 and 3, the data is simultaneously sent to CPU 100 which can be utilized to verify whether the data was valid or not. It can also be utilized to perform a host of other functions.

The present invention provides a hardware and software solution to CPU latency and increase the efficiency by at least one third during the period when data is being transmitted to the CAM or similar device. It should be noted that signal being carried by line 125 does not have to be sent to CPU 100, but may be eliminated. It should also be noted that the decoder functions can be performed by register 220 or even supplied in the address information provided by the CPU 100.

It will be apparent to those skilled in the art that various modifications and variations can be made in the present invention and in construction of this invention without departing from the scope or spirit of the invention. Other embodiments of the invention will be apparent to those skilled in the art from consideration of the specification and practice of the invention disclosed herein. It is intended that the specification and examples be considered as exemplary only.

The Decoder 240, as shown in FIG. 3, is a conventional address decoder. It's inputs are CPU address and control lines. When the address and control lines output by CPU 100 on Bus 105 matches the pre-defined address of CAM 150, Decoder 240 activates its output signal 145, which directs CAM 150 to place it's data on bus 125.

Hardware register 220 provides a real-time indication of changing events. For example, when H/W register 220 is connected to I/O port circuitry, H/W register 220 can provide indication that a ‘frame’ of data has been received. This indication is provided by one or more bits changing state in the data which is read from H/W register 220 by CPU 100. H/W register 220 may also provide supplemental information, such as the destination address of the frame just received. H/W register 220 typically has ‘destructive’ reading characteristics, which means that one or more of the data bits read by CPU 100, will change state after the CPU read completes.

As shown in FIG. 3, in addition to outputting it's data on bus 125, H/W register 220 also examines it's own data bits at the same time it drives Bus 125. If certain, pre-defined bits are in an active state, H/W register 220 also drives signal 215 active, directing Decoder 240 to activate signal 145 and write data on bus 125 into CAM 150. In other words, the same data read by CPU 100 is written to CAM 150, in a single bus cycle, based upon certain bits in the data.

The reader is now directed to FIG. 4 and FIG. 5 wherein the logic utilize to initialize and operate embodiments of the present invention are depicted.

FIGS. 4 and 5 depicts the input and output signals utilized in the present invention. CLK53 is a system clock, running at 53 megahertz in this embodiment. A[27 . . . 24] are four CPU address bits. Three address bits with AND3 are used to detect a CPU access of H/W register 220 and activate signal CAM_ADR. The number of address bits used is system dependent.

PGA_RD is the signal provided by Decoder 110 on line 115. PGA_RD is an address and control line decoder. SOF_VLD is a data bit which when active during a read of H/W register 220, results in activation of signal CAM_LD_EN. CAM_LD_EN is signal 215. CAM_LD_EN goes active when CPU 100 reads H/W register 220 and SOF_VLD is active.

In operation CAM_LD_EN decodes address and data at the same time. When CPU 100 reads H/W register 220, CAM_ADR and PGA_RD (addresses) become active. If SOF_VLD (data) is active at this time, CAM_LD_EN goes active on the next clock edge. In this embodiment, a NOT gate is used to force CAM_LD_EN inactive after one clock cycle.

CAM_ADR is a signal which is asserted when the CPU is reading Hardware register 220, and the CPU wants the data from hardware register 220 to be written to CAM 150. The AND3 gate is a partial representation of a conventional address decoder. In FIG. 4, the CPU puts the value 011 binary on address lines A(27-25), which results in the assertion of signal CAM_ADR. CAM_ADR is subsequently used in FIG. 5.

The signal PGA_RD is also an address decoder output like CAM_ADR. PGA_RD decodes address lines in addition to A(27-25) as well as CPU control lines. The signal SOF_VLD is one of the data bits read from hardware register 220. The AND4 gate shown, detects the presence of the two address decodes (CAM_ADR and PGA_RD) and the data bit SOF_VLD. When all are true, signal CAM_LD_EN is asserted. So, CAM_LD_EN is asserted when the CPU reads a particular address and a particular data bit is asserted. CAM_LD_EN is signal 215 in FIGS. 2 and 3. The NOT gate is insignificant; in this implementation, it insure CAM_LD_EN only remains on for one clock.

In an alternate embodiment, depicted in FIG. 2, the H/W register 220 outputs its data on bus 125 and also examines, or samples one or more of its data bits at the same time it drives bus 125 . If certain pre-defined bits are in an active state (i.e., the most-significant or any pre-defined group of bits) H/W register 220 makes bus 215 active, instructing CAM 150 that the data is valid. In this embodiment Decoder 240 bus line 145 are eliminated. The functionality provided via decoder 240 is capable of being provided by H/W register 220.

It will be apparent to those skilled in the art that various modifications and variations can be made in the present invention and in construction of the present invention without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for reducing CPU code latency by writing data to hardware devices on behalf of said CPU, the method comprising:
directing a register to drive data via a first device;
driving the data via the register to the first device and a second device simultaneously;
sampling of the data by the register and determining whether the data is valid; and
signaling the second device as to whether the data is valid or invalid.

2. The method for reducing CPU code latency by writing data to hardware devices on behalf of said CPU according to claim 1, wherein the register is capable of analyzing at least one bit of the data to determine if the data is valid or invalid.

3. The method for reducing CPU code latency by writing data to hardware devices on behalf of said CPU according to claim 2, wherein the bit analyzed in determining the validity of the data is at least one of a most significant bit and a least significant bit.

4. The method for reducing CPU code latency by writing data to hardware devices on behalf of said CPU according to claim 2, wherein the first device comprises a CPU.

5. The method for reducing CPU code latency by writing data to hardware devices on behalf of said CPU according to claim 1, wherein the second device comprises a memory device.

6. The method for reducing CPU code latency by writing data to hardware devices on behalf of said CPU according to claim 5, wherein the memory device further comprising at least one of a content addressable memory, a hardware register and a storage medium.

7. An apparatus for reducing CPU bus cycle time and CPU latency in responding to real-time events, the apparatus comprising:
a CPU in communication with and capable of directing a first hardware device;
the first hardware device responsive to the CPU and capable of driving data pursuant to instructions from the CPU, wherein the hardware device is further capable of:
substantially simultaneously driving data to the CPU and a second hardware device;
analyzing one or more bits from the data driven by the first hardware device in determining validity of the data; and
transmitting a signal to the second hardware device regarding the validity of the data.

8. The apparatus for reducing CPU bus cycle time and CPU latency in responding to real-time events according to claim 7, wherein the first hardware device comprises a hardware register.

9. The apparatus for reducing CPU bus cycle time and CPU latency in responding to real-time events according to claim 8, wherein the second hardware device comprises a writable hardware device.

10. The apparatus for reducing CPU bus cycle time and CPU latency in responding to real-time events according to claim 9, wherein the writable hardware device comprises at least on of a storage medium, content address memory and a register.

11. The apparatus for reducing CPU bus cycle time and CPU latency in responding to real-time events according to claim 7, wherein the first hardware device analyze at least one of a most-significant-bit and a least significant bit in determining the validity of the data.

12. The apparatus for reducing CPU bus cycle time and CPU latency in responding to real-time events according to claim 7, wherein the validity signal is transmitted to the second hardware device at approximately near completion of a read cycle of the CPU.

13. An apparatus for reducing CPU latency by reducing CPU bus read/write cycles, the apparatus comprising:
a hardware register capable of testing data for one or more validity bits;
a CPU in communication with the hardware register during a first bus cycle, wherein the CPU directs the hardware register to drive the data substantially simultaneously to the CPU and a second register and in close proximity to the data transfer, the hardware register sends a validity signal to the second register without a subsequent bus cycle instruction to the second register from the CPU.
